(19) United States
(12) Patent Application Publication
(10) Pub. No.: US 2013/0163251 A1
(43) Pub. Date: Jun. 27, 2013

(54) Electronic dartboard having LEDs

(71) Applicant: Cheng Pao Yang, New Taipei City (TW)

(72) Inventor: Cheng Pao Yang, New Taipei City (TW)

(21) Appl. No.: 13/716,206

(22) Filed: Dec. 17, 2012

(30) Foreign Application Priority Data
Dec. 27, 2011 (CN) 201120554563.7

(51) Int. Cl. F21V 33/00

(52) U.S. Cl. CPC F21V 33/008
USPC 362/249.06

(57) ABSTRACT

An electronic dartboard is provided with a circular, outer LED layer; a circular, intermediate thin membrane switch layered structure including a controller; and a circular, inner scoring layer. The scoring layer is divided into a plurality of radial sections. The LED layer includes at least one LED on each of a plurality of virtual sections corresponding to the section of the scoring layer. The thin membrane switch layered structure and the at least one LED are electrically connected to the controller.

### BACKGROUND OF THE INVENTION

1. Field of the Invention

The invention relates to electronic dartboards and more particularly to an electronic dartboard having a plurality of LEDs.

2. Description of Related Art

There are electronic dartboards commercially available. These dartboards have electronic scoring computers that are preprogrammed with a wide variety of game types. The board is made of plastic facings with small holes. The holes are slant out to allow plastic-tipped darts to stick inside. When a dart strikes the board, the section makes contact with a metal plate, telling the computer where the player has thrown.

A conventional multiple target electronic dart game has shared microprocessor that monitors and services operation of the electronic dart game. Multiple targets are mounted on opposite sides of a column which may be wall mountable. Affixed to top of the column is a video monitor for providing players and observers with game scores. Many components of the electronic dart game are shared.

Notwithstanding the prior art, the invention is neither taught nor rendered obvious thereby.

### SUMMARY OF THE INVENTION

It is therefore one object of the invention to provide an electronic dartboard comprising a circular, outer light-emitting diode (LED) layer; a circular, intermediate thin membrane switch layered structure including a controller; and a circular, inner scoring layer; wherein the scoring layer is divided into a plurality of radial sections; wherein the LED layer includes at least one LED on each of a plurality of virtual sections corresponding to the section of the scoring layer; and wherein the thin membrane switch layered structure and the at least one LED are electrically connected to the controller.

In a first aspect of the invention, there are further provided with a plurality of pins disposed into a plurality of holes on each of the scoring layer, the LED layer and the thin membrane switch layered structure to fasten them together.

In a second aspect of the invention, each section of the LED layer comprises at least one LED.

In a third aspect of the invention, each section of the LED layer comprises an LED corresponding to a center of the section of the scoring layer.

In a fourth aspect of the invention, each section of the LED layer comprises an LED corresponding to a peripheral edge of the section of the scoring layer.

In a fifth aspect of the invention, each section of the LED layer comprises two LEDs corresponding to a peripheral edge of the section of the scoring layer.

It is another object of the invention to provide an electronic dartboard comprising a circular, outer thin membrane switch layered structure including a controller; a circular, intermediate light-emitting diode (LED) layer; and a circular, inner scoring layer; wherein the scoring layer is divided into a plurality of radial sections; wherein the LED layer includes at least one LED on each of a plurality of virtual sections corresponding to the section of the scoring layer; and wherein the thin membrane switch layered structure and the at least one LED are electrically connected to the controller.

The above and other objects, features and advantages of the invention will become apparent from the following detailed description taken with the accompanying drawings.

### BRIEF DESCRIPTION OF THE DRAWINGS

FIG. 1 is an exploded perspective view of an electronic dartboard according to the invention;

FIG. 2 is an exploded view of the electronic dartboard; and

FIG. 3 is a block diagram of a controller of the invention.

### DETAILED DESCRIPTION OF THE INVENTION

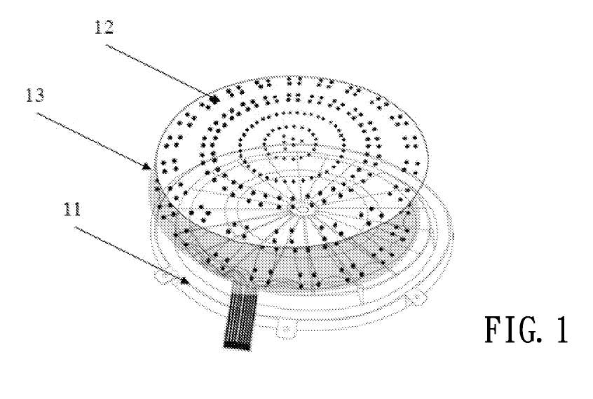

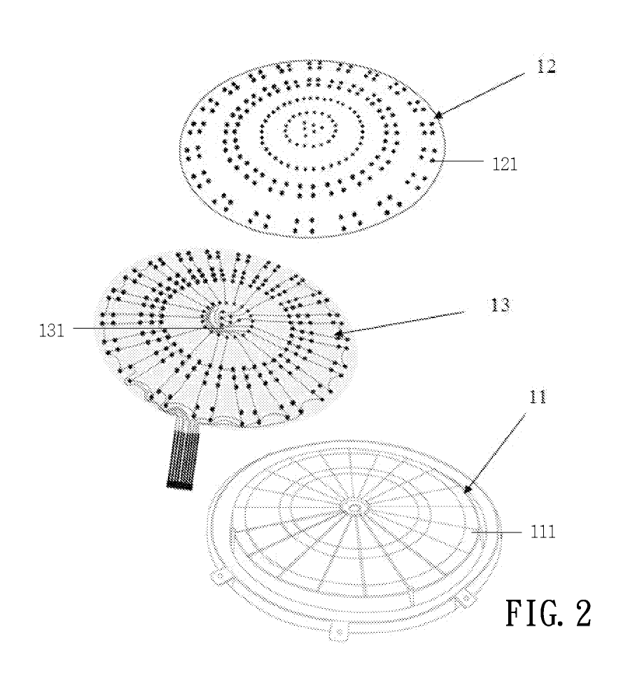

Referring to FIGS. 1 to 3, an electronic dartboard in accordance with the invention comprises the following components as discussed in detail below.

A circular, outer light-emitting diode (LED) layer 12, a circular, intermediate thin membrane switch layered structure 13, and a circular, inner scoring layer 11 are provided in a stack manner. The scoring layer 11 is divided into a plurality of radial sections 111. The thin membrane switch layered structure 13 and the LED are electrically connected to a controller 131 which will be discussed later.

A plurality of pins are provided on a support member of wall so that the pins can be snugly fitted into a plurality of holes on each of the scoring layer 11, the LED layer 12 and the thin membrane switch layered structure 13 to fasten them together.

Each of a plurality of virtual sections of the LED layer 12 comprises at least one LED 121 each corresponding to a center of the section 111 of the scoring layer 11. Alternatively, each of a plurality of virtual sections of the LED layer 12 comprises an LED 121 corresponding to a peripheral edge of the section 111 of the scoring layer 11. Still alternatively, each of a plurality of virtual sections of the LED layer 12 comprises two LEDs 121 corresponding to the peripheral edge of the section 111 of the scoring layer 11.

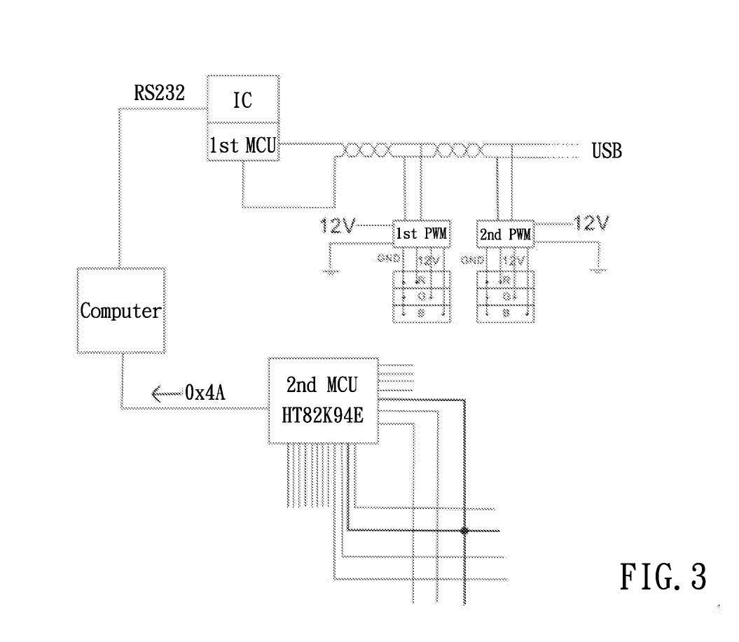

Referring to FIG. 3 specifically, the controller 131 comprises an LED control section (see an upper part of FIG. 3) and a dart strike sensing section (see a lower part of FIG. 3). The thin membrane switch layered structure 13 has upper and lower layers in which seven pins of the lower layer are connected to input ports of a first microcontroller unit (MCU) and 12 pins of the upper layer are connected to output ports of the first MCU. As a result, a 7×12 switch matrix is formed. An output terminal of the first MCU is electrically connected to the pins of the lower layer of the thin membrane switch layered structure 13 sequentially. In response to a dart striking through the LED layer 12 onto the upper layer of the thin membrane switch layered structure 13, one switch of the 7×12 switch matrix is closed by contacting the corresponding pin of the lower layer of the thin membrane switch layered structure 13. And in turn, a sense signal is transmitted to an input terminal of the first MCU. And in turn, the first MCU encodes an index of the current output pin and an index of the pin receiving the sense signal into a 16-bit code including a high byte and a low byte (e.g., 0×4A as shown). The 16-bit code is transmitted to a computer via a Universal Serial Bus human interface device (USB HID) interface. Further, the computer can convert a coordinate of the LED 121 corresponding to the dart striking section into an LED index in the range of 1 to 82. A specific color is associated with and assigned to the LED index and an illumination instruction containing both the color and the LED index is thus created. The illumination instruction is then sent to an integrated circuit (IC) via RS-232. A second MCU electrically connected to the IC may convert the LED index of the illumination instruction into an address mask and the color of the illumination instruction into a red, green, and blue (RGB) triplet. Both the address mask and the RGB triplet are sent to a first Pulse Width Modulation (PWM) amplifier or a second PWM amplifier based on the value of the address mask via a Universal Serial Bus (USB). The chosen first or second PWM amplifier will further convert the RGB triplet into electric currents having different values which are in turn sent to the LEDs 121 to illuminate a corresponding color light.

While the invention has been described in terms of preferred embodiments, those skilled in the art will recognize that the invention can be practiced with modifications within the spirit and scope of the appended claims.

What is claimed is:

1. An electronic dartboard comprising:
a circular, outer light-emitting diode (LED) layer;
a circular, intermediate thin membrane switch layered structure including a controller; and
a circular, inner scoring layer;
wherein the scoring layer is divided into a plurality of radial sections;
wherein the LED layer includes at least one LED on each of a plurality of virtual sections corresponding to the section of the scoring layer; and
wherein the thin membrane switch layered structure and the at least one LED are electrically connected to the controller.

2. The electronic dartboard of claim 1, further comprising a plurality of pins disposed into a plurality of holes on each of the scoring layer, the LED layer, and the thin membrane switch layered structure to fasten them together.

3. The electronic dartboard of claim 2, wherein each section of the LED layer comprises at least one LED.

4. The electronic dartboard of claim 3, wherein each section of the LED layer comprises an LED corresponding to a center of the section of the scoring layer.

5. The electronic dartboard of claim 3, wherein each section of the LED layer comprises an LED corresponding to a peripheral edge of the section of the scoring layer.

6. The electronic dartboard of claim 3, wherein each section of the LED layer comprises two LEDs corresponding to a peripheral edge of the section of the scoring layer.

7. An electronic dartboard comprising:
a circular, outer thin membrane switch layered structure including a controller;
a circular, intermediate light-emitting diode (LED) layer; and
a circular, inner scoring layer;
wherein the scoring layer is divided into a plurality of radial sections;
wherein the LED layer includes at least one LED on each of a plurality of virtual sections corresponding to the section of the scoring layer; and
wherein the thin membrane switch layered structure and the at least one LED are electrically connected to the controller.

8. The electronic dartboard of claim 7, further comprising a plurality of pins disposed into a plurality of holes on each of the scoring layer, the LED layer, and the thin membrane switch layered structure to fasten them together.

9. The electronic dartboard of claim 8, wherein each section of the LED layer comprises at least one LED.

10. The electronic dartboard of claim 9, wherein each section of the LED layer comprises an LED corresponding to a center of the section of the scoring layer.
